(19) United States
(12) Patent Application Publication
(10) Pub. No.: US 2025/0196305 A1
(43) Pub. Date: Jun. 19, 2025

(54) Multi-Tool

(71) Applicant: AOB Products Company, Columbia, MO (US)

(72) Inventors: Derek Wright, Columbia, MO (US); Michael Cottrell, Ashland, MO (US); Zach Smith, Columbia, MO (US); Brett Eckelkamp, Fulton, MO (US); James Tayon, Moberly, MO (US); Jason Nickerson, Columbia, MO (US)

(73) Assignee: AOB Products Company, Columbia, MO (US)

(21) Appl. No.: 18/982,280

(22) Filed: Dec. 16, 2024

Related U.S. Application Data
(60) Provisional application No. 63/610,873, filed on Dec. 15, 2023.

(51) Int. Cl. B25F 1/00; B25F 1/04

(52) U.S. Cl. CPC B25F 1/003; B25F 1/04

(57) ABSTRACT

A multi-tool kit or system, components thereof, and associated methods. The multi-tool kit enables enabling a user to assemble a multi-tool with desired tools. The multi-tool kit may include different tool heads, different handles, and/or different removeable tools from which the user can select and assemble into a multi-tool.

### CROSS-REFERENCE TO RELATED APPLICATION

This application claims priority to U.S. Provisional Application No. 63/610,873, filed Dec. 15, 2023, the entirety of which is hereby incorporated by reference.

### FIELD

The present disclosure generally relates to a tool, and more particularly to a multi-tool.

### BACKGROUND

A multi-tool is a portable device easily carried by a person, such as in a pocket or on a belt. A multi-tool has a variety of different tools (knife, screwdriver, etc.) a user a select from for a given task.

### SUMMARY

In one aspect, a multi-tool comprises a first tool including a handle connector. A handle includes a handle body having a tool receiving space. The handle includes a tool connector configured to releaseably connect to the handle connector of the first tool to releaseably connect the first tool and the handle together. The handle includes a second tool different than the first tool. The second tool is supported by the handle body. The second tool is moveable between a stowed position in which the second tool is disposed in the tool receiving space of the handle body and an operational position in which the second tool is disposed outside the tool receiving space.

In another aspect, a multi-tool kit comprises first and second tools and first and second handles. The first tool includes a first handle connector and a second handle connector. The second tool is different than the first tool. The second tool includes a third handle connector and a fourth handle connector. The first handle includes a first handle body and a first tool connector. The second handle is different than the first handle and includes a second handle body and a second tool connector. The multi-tool kit is assembleable into a first assembly and a second assembly. In the first assembly, the first tool connector of the first handle is connected to the first handle connector of the first tool and the second tool connector of the second handle is connected to the second handle connector of the first tool. In the second assembly the first tool connector of the first handle is connected to the third handle connector of the second tool and the second tool connector of the second handle is connected to the fourth handle connector of the second tool.

In another aspect, a multi-tool comprises a handle body having a tool receiving space. The handle body includes a first straight edge. A first tool is supported by the handle body. The first tool is moveable with respect to the handle body between a stowed position in which the first tool is disposed in the tool receiving space of the handle body and an operational position in which the second tool is disposed outside the tool receiving space. An angle tool is supported by the handle body and includes a second straight edge. The second straight edge is pivotable with respect to the handle body from a stowed position to a first operational position in which the first and second straight edges form a first preset angle and to a second operational position in which the first and second straight edges form a second preset angle different than the first preset angle. The handle body and the angle tool form an angle tool arrangement. The angle tool arrangement includes a retainer configured to positively locate and retain the angle tool in the first and second operational positions, or the angle tool arrangement includes degree indicia and a reference moveable with respect to the degree indicia to permit a user to identify the first and second straight edges form the first and second preset angles based on a location of the reference relative to the degree indicia.

Other objects and features of the present disclosure will be in part apparent and in part pointed out herein.

### BRIEF DESCRIPTION OF THE DRAWINGS

FIG. 1 is an elevation view of a multi-tool according to one embodiment of the present disclosure, the multi-tool in an operational arrangement;

FIG. 2 is an elevation view of the multi-tool in a stowed arrangement;

FIG. 3 is an elevation view of various multi-tool assemblies according to one embodiment of the present disclosure using different tool heads;

FIGS. 4A-D illustrate the connection between a tool head and a handle according to one embodiment of the present disclosure;

FIG. 5 is an elevation view of various tools of the present disclosure connectable to the handle;

FIG. 6 is an elevation view of a first configuration of a handle for the multi-tool according to one embodiment of the present disclosure;

FIG. 7 is additional views of the handle of FIG. 6.

FIG. 8 is an elevation view of a second configuration of a handle for the multi-tool according to one embodiment of the present disclosure;

FIG. 9 is additional views of the handle of FIG. 8;

FIG. 10 is an elevation view of a third configuration of a handle for the multi-tool according to one embodiment of the present disclosure;

FIG. 11 is additional views of the handle of FIG. 10;

FIG. 12 is an elevation view of a fourth configuration of a handle for the multi-tool according to one embodiment of the present disclosure;

FIG. 13 is additional views of the handle of FIG. 12; and

FIG. 14 illustrates the switchability of the tools with the handles of the multi-tool according to one embodiment of the present disclosure.

Corresponding reference characters indicate corresponding parts throughout the drawings.

### DETAILED DESCRIPTION

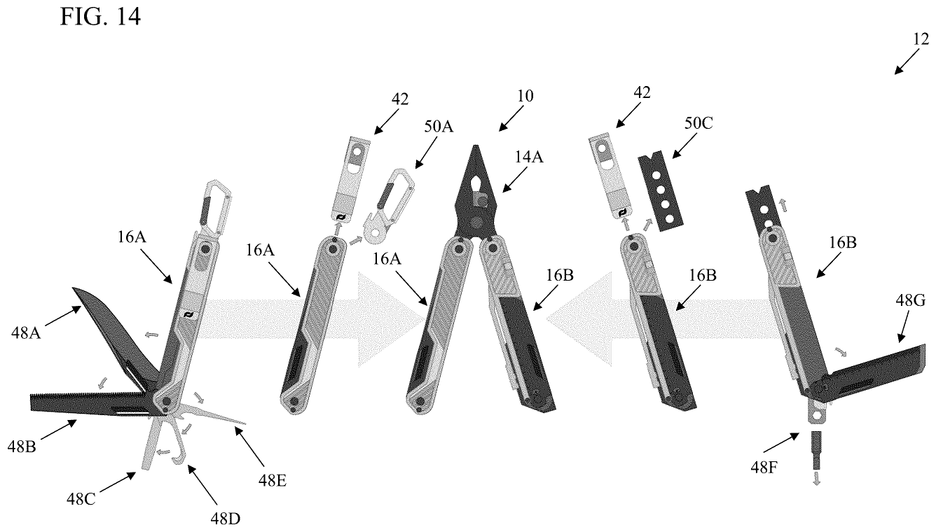

The present disclosure is directed to a multi-tool (broadly, a multi-tool assembly), generally indicated at reference numeral 10, and to components thereof and associated methods. The multi-tool 10 may be assembled from components (e.g., handles, tools, etc.) of a multi-tool system or kit 12 (e.g., FIG. 14). The multi-tool kit includes various tools of different types and various handles of different configurations. A user can select the desired tool(s) and/or handle(s) with which to build the multi-tool. This allows a user to customize the multi-tool 10 as desired. For example, the user can select which type of tool(s) to attach to the handle(s) and/or which configuration of handle(s) to attach to the tool(s) to build a multi-tool containing the tools according to their preference or need.

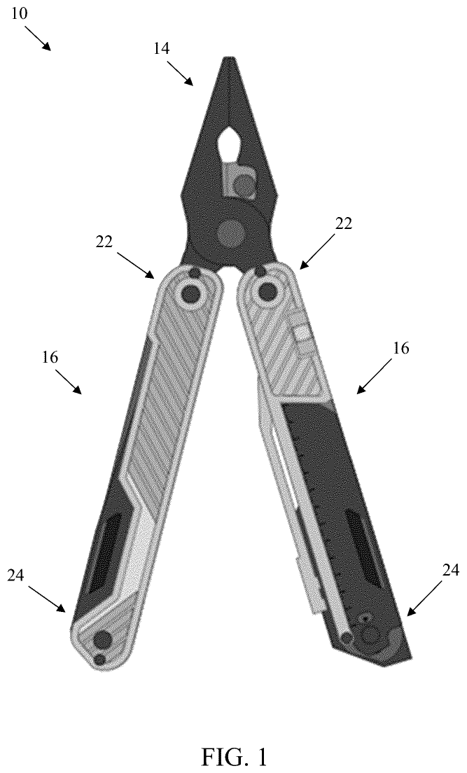

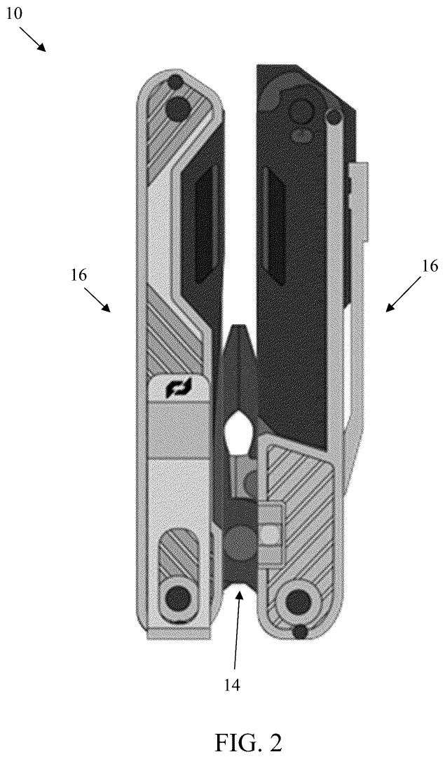

Referring to FIGS. 1 and 2, the multi-tool 10 includes a tool head 14 (broadly, a tool) connected to at least one handle 16. In the illustrated embodiment, the multi-tool 10 includes two handles 16 connected to the tool head 14. The two handles 16 may be identical or may have different configurations. The handle 16 is independently pivotable (broadly, moveable) relative to the tool head 14. Each handle 16 includes a handle body 18 having (e.g., defining) a recess or tool receiving space 20 (FIG. 7). The handle body 18 is generally elongate with opposite first and second ends. The handle body 18 may be made up of one or more pieces (e.g., a frame with grips attached to either side, or an integral, one-piece body). The recess 20 is bounded by opposite spaced apart side walls or portions of the handle body 18. The handle body 18 includes a base bounding the bottom of the recess 20 and an open top (broadly, open side) opposite the base. The multi-tool 10 is configurable or moveable between a first or stowed arrangement (FIG. 2) and a second or operational arrangement (FIG. 1). In the stowed arrangement, the handles 16 are pivoted to a first or stowed position (relative to the tool head 14) such that each recess 20 of the two handles 16 receives the tool head (a portion thereof). In the operational arrangement, the handles are pivoted to a second or operational position (relative to the tool head 14) such that tool head is disposed outside of the recesses 20 and exposed to be used. The pivoting of each handle 16 between the stowed and operational positions may be in the inclusive range of about 135-180 degrees. Each handle 16 may include a tool head keeper or retainer to prevent the tool head and handle from pivoting relative to one another, such as lockback (also called a backlock or back-lock) or a liner lock, although the use of other types of keepers may be used without departing from the scope of the present disclosure. In various embodiments, a slip joint may be used to bias the handle in one of the stowed or operational positions relative to the tool head.

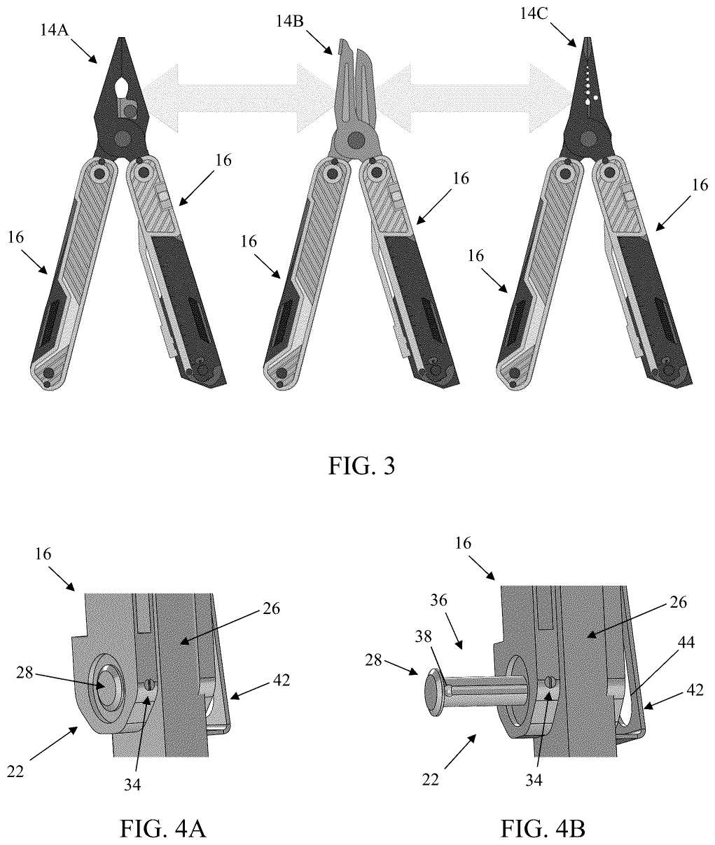

With reference to FIG. 3, the handles 16 of the multi-tool 10 are connectable and disconnectable from the tool head 14. This allows the handles 16 to be connected to different tool heads 14 (broadly, tools), thereby allowing the user to select a desired tool head for the multi-tool 10, and thereby allowing the user to select the handle(s) to be used with a chosen tool head. In the illustrated embodiment, the tool heads 14 include a plier tool head 14A, a shear (e.g., scissor or cutter) tool head 14B, and a wire stripper tool head 14C (all, broadly, “jawed tool heads”), although other types of tool heads may be used without departing from the scope of the present disclosure. For example, the multi-tool 10 can include a crescent wrench tool head, a hammer tool head, etc., which may or may not be pivotable relative to the handle 16 and/or disposed in the recess 20 of the handle 16 in the stowed position. The tool head 14 may connect to two handles 16, as shown in FIG. 3, or may connect to only one handle. Each of the illustrated tool heads 14 includes a pivot connection about which two members (e.g., jaws, scissor blades, etc.) are pivoted. Each handle 16 is connected to one of the members for pivoting that member about the pivot connection relative to the other member (and other handle) when the multi-tool 10 is in the operational arrangement.

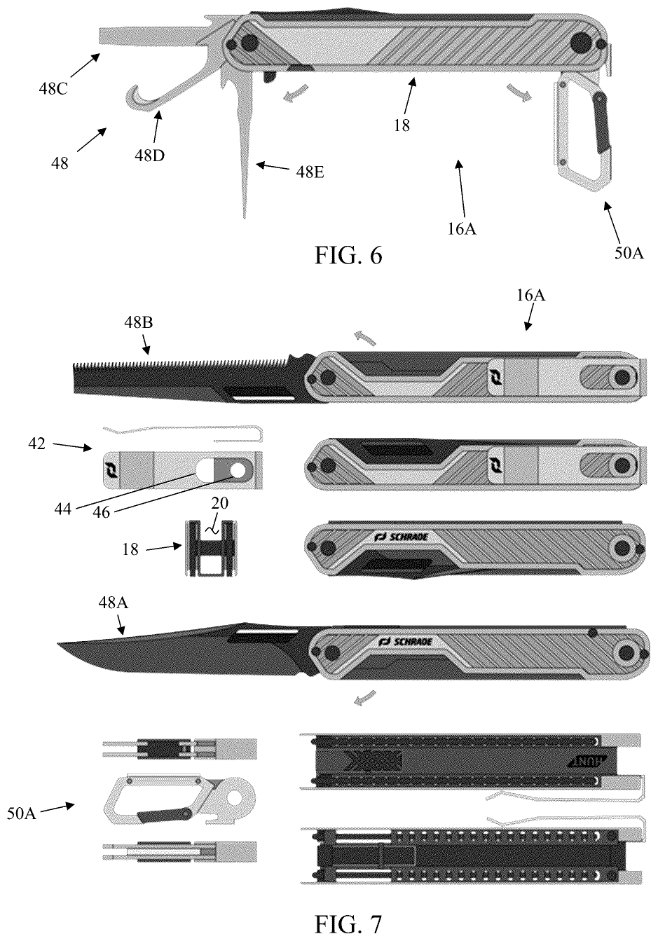

The handle 16 includes a first or releaseable tool connector 22 (e.g., a tool head connector) and a second tool connector 24. The releaseable tool connector 22 (broadly, tool connector) is disposed at or adjacent to one end of the handle body 18. The second tool connector is disposed at or adjacent to the opposite end of the handle body 18. The releaseable tool connector 22 permits the tool head 14 (broadly, tool) to be connected and disconnected from the handle 16, thereby enabling the switchability of different tool heads 14 and different handles with one another. The second tool connector 24 connects one or more additional (e.g., second, third, fourth, etc.) tools 48 (FIGS. 6-12) to the handle body 18. Such additional tools 48 can be one or more of (including any combination thereof) a knife, a saw, a screwdriver (Philips, flathead, etc.), can opener, gut hook, etc. Other types of tools can be used without departing from the scope of the present disclosure. Generally, the tools 48 of the system will be different (e.g., a different type, size, and/or configuration of tool) and will be different than the tool head 14. The additional tools 48 are supported and carried by the handle body 18. In the illustrated embodiment, the second tool connector 24 comprise a pin or shaft that permits each tool 48, individually, to be pivoted (broadly, moved) relative to the handle body 18 of the handle 16 (and the other tools 48) between a stowed position (the tool disposed in the recess 20 of the handle body) and an operational position (the tool is outside the recess for use). The pivoting of each tool 48 between the stowed and operational positions may be about 180 degrees. The handle body 18 may include one or more dividers that divide the recess 20 into different sections that receive different tools 48. The pin of the second tool connector 24 can be fixed to the handle body 18 (such that the tools 48 are irremovably connected to the handle body), or the second tool connector can have generally the same (if not identical) configuration as the releaseable tool connector 22 (e.g., a movable connector pin 28 as described below), thereby allowing the user to pick and choose which tools 48 are coupled to the handle body. The handle may include a tool keeper or retainer to prevent the tools 48 from pivoting relative to the handle body 18, such as lockback or a liner lock. Moreover, a slip joint or other configuration can be used without departing from the scope of the present disclosure.

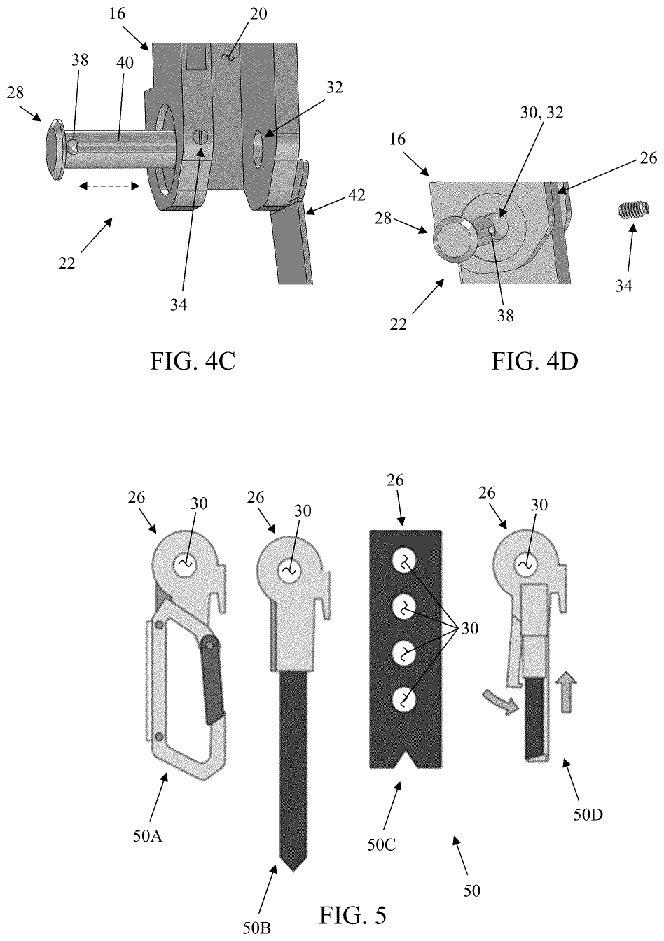

With reference to FIGS. 4A-D, one releaseable tool connector 22 and the tool-to-handle connection formed thereby will now be described with the understanding the description applies to all tool-to-handle connections (e.g., tool head 14 to handle) formed by the releaseable tool connector. The tool head 14 includes a handle connector 26. The releaseable tool connector 22 and the handle connector 26 releaseably connect to one another to releaseably connect the tool head 14 and the handle 16 together. The illustrated tool heads 14 each include two (e.g., a first and a second) handle connector 26, one for each handle 16. The releaseable tool connector 22 includes a connector or connection pin or shaft 28 (broadly, an insert). The handle connector 26 includes an opening 30 (broadly, a receiver that receives the insert). The handle connector 26 is formed (e.g., be part of) a portion (e.g., leg) of the tool head 14. The connector pin 28 is sized and shaped to be inserted into the opening 30. In the illustrated embodiment, the connector pin 28 extends through the opening 30. The handle body 28 includes openings 32 in each side wall that receive the connector pin 28. The releaseable tool connector 22 and the handle connector 26 form a pivot connection permitting the tool head 14 and the handle 16 to pivot relative to one another between the stowed and operational positions. Specifically, the tool head 14 and/or the handle 16 pivot about the connector pin 28 to move between the stowed and operational positions. The body of the tool head 14 is sized and shaped to not interfere with the handle 16 to permit pivoting between the stowed and operational positions. Further, the body of the tool head 14 may be sized and shaped to contact the body of the handle 16 to brace the tool head with respect to the handle and prevent pivoting of the tool head with respect to the handle, when in the operational position.

The connector pin 28 is supported by (e.g., carried by) the handle body 18. The connector pin 28 is also moveable relative to the handle body 18 between a first or connecting position (FIG. 4A) and a second or release position (FIGS. 4B and C). The connector pin 28 may be supported by the handle body 18 in both the connecting and release positions. In the illustrated embodiment, the connector pin 28 moves linearly along the connector pin's longitudinal axis (generally perpendicular to the handle body's longitudinal axis) between the connecting and release positions. The connector pin 28 linearly slides relative to the handle body 18 (in the openings 32 in the side walls). The connector pin 28 moves between the connecting and release positions without rotating, although other configurations can be used. In the connecting position, the connector pin 28 is arranged to extend into the opening 30 of the handle connector 26 to connect the tool head 14 (broadly, tool) and the handle 16 together. The connector pin 28 extends through the handle connector 26 and bridges the two side walls of the handle body 18 (through the tool head 14) to couple the handle 16 and the tool head together. In the release position, the connector pin 28 is arranged to not extend into (e.g., through) the opening 30 of the handle connector 26 to permit the separation of the tool head 14 and the handle 16 (and the alignment of the opening with the connector pin for connection of the tool head and the handle). The connector pin 28 is not disposed in the opening 30 in the handle connector 26, thereby allowing the tool head 14 to be disconnected from the handle 16. Other configurations can be used without departing from the scope of the present disclosure.

The handle 16 includes a retainer arrangement for preventing the connector pin 28 from inadvertently moving out of the connecting position and/or release position. In the illustrated embodiment, the retainer arrangement includes a retainer 34 and a keeper 36. The retainer 34 holds the connector pin 28 in at least one of the connection position or the release position, desirably, both. The retainer 34 is connected to and supported by the handle body 18. The connector pin 28 includes the keeper 36 in the form of first and second recesses 38 (e.g., detent recesses). The retainer 34 comprises a detent sized and shaped to fit in the first and second recesses 38 to hold the connector pin 28 in the connecting and retracted positions, respectively. One recess 38 is adjacent the head of the connector pin 28 and the other recess 38 is adjacent the free end of the connector pin. A groove or channel 40 (e.g., detent groove or channel) may extend between the first and second recess, in which the detent rides as the pin is moved between the connecting and retracted positions. In the illustrated embodiment, the retainer 34 comprises a set screw with an integral detent (e.g., ball or pin) and detent spring that biases the detent toward the connection pin. In other embodiments, the set screw, detent, and detent spring may be separate pieces such that the detent spring is sandwiched between the detent and the set screw. Other retainer arrangements can be used without departing from the scope of the present disclosure.

In the connecting position, the free end of the connector pin 28 (opposite the head of the connector pin) is arranged to be pressed by a user to move the connector pin toward the release position. The free end of the connector pin 28 is exposed or otherwise located to be pushable by the user. The free end of the connector pin 28 may be flush with an exterior surface or face of the handle body 28 (e.g., a side wall thereof) or may be proud (extend exteriorly relative to) the exterior surface of the handle body. To disconnect the tool head 14 (broadly, tool) and the handle 16 from one another, the user disconnects the releaseable tool connector 22 and the handle connector 26. The user pushes on the exposed end of the connector pin 28 with their finger with sufficient force to overcome the retaining force of the retainer 34 (dislodge the detent from the first recess 38). After the free end moved is moved sufficiently, the user can then pull on the head of the connector pin 28 to finish moving the connector pin to the release position (e.g., out of the opening 30 of the handle connector 26). Now the user can remove the tool head 14 (broadly, tool) and replace it with another tool head or another element (e.g., tool). The user arranges the handle connector 26 of the new tool head 14 so that the opening 30 is aligned with the connector pin 28 and then pushes the head of the connector pin. The connector pin 28 moves from the release position, through the opening 30 in the handle connector 26 and into the connecting position, thereby connecting the new tool head 14 to the handle 16. Alternatively, the handle 16 can be used as its own tool assembly (broadly, multi-tool) without being connected to a tool head 14.

As is apparent, the releaseable tool connector 22 allows toolless connection and disconnection of the tool (e.g., tool head 14) with the handle 16. The releaseable tool connector 22 and the handle connector 26 are manually connectable and disconnectable without the use of a tool or other implement. However, it is understood tools may be used without departing from the scope of the present disclosure.

The multi-tool may include a belt clip 42. In the illustrated embodiment, the belt clip 42 (broadly, a guard or shield) generally protects the exposed free end of the connector pin 28 and prevents something from unintentionally pushing on the free end of the connector pin, thereby moving the connector pin from the connecting position. The belt clip 42 overlies the end of the connector pin 28 when the pin is in the connection position to prevent inadvertent pressing of the connector pin toward the release position. The belt clip 42 has a finger opening 44 aligned with the free end of the connector pin 28. The finger opening 44 is sized and shaped to permit a finger of the user to access the connector pin 28 by extending through the finger opening to press the free end of the connector pin. In this embodiment, the belt clip 42 includes an in-turned flange or connection portion that wraps around an end of the handle body 18 and include an opening 46 (like opening 30) (FIG. 7) through which the connector pin 28 extends (in the connecting position) to releaseably attach the belt clip to the handle body. This allows the belt clip 42 to be connectable to and disconnectable (e.g., removeable) from the handle body 18 in the same manner as the tool head 14 described above. Other configurations of the belt clip, such as the belt clip being fixed to the handle body 18 and/or fastened to the handle body in other ways, may be used without departing from the scope of the present disclosure.

Referring to FIGS. 5-13, each handle 16 of the multi-tool 10 can be used independently or without the tool head 14. The releaseable tool connector 22 enables other components (e.g., removeable tools) besides the tool head 14 to be connected to the handle 16. In one embodiment, the multi-tool kit 12 includes one or more removeable tools 50. For example, with reference to FIG. 5, the illustrated removeable tools 50 include a caribener 50A, a pen and/or glass breaker 50B (e.g., a pen/glass breaker combination tool), a pry bar 50C, and a fire starter 50D. Other types of tools, such as eating utensils (e.g., fork, knife, spoon, spork), can opener, etc., can be a removeable tool part of the system without departing from the scope of the present disclosure. Each removeable tool 50 can be connected to and disconnected from the handle 16 in the same manner discussed above with respect to the tool head 14. Each removeable tool 50 includes a handle connector 26 (with at least one opening 30) that releaseably connects to the releaseable tool connector 22 of the handle 16. The connector pin 28 extends through the opening 30 to connect the removeable tool 50 to the handle. The handle connector 26 of the removeable tool 50 and the releaseable tool connector 22 of the handle 26 may or may not form a pivot (broadly, moveable) connection. For example, the handle connector 26 of each of the caribener 50A, pen and/or glass breaker 50B, and fire starter 50D and the releaseable tool connector 22 of the handle 26 form a pivot connection (when connected together) allowing the removeable tool 50 to be pivoted or rotated (about the connector pin 28) between stowed (tool disposed in the recess 20 of the handle body 18) and operational positions (tool disposed outside the recess of the handle body), similar to the tool head 14. The body of the removeable tool 50 is sized and shaped to not interfere with the handle 16 to permit pivoting between the stowed and operational positions. Further, the body of the removeable tool 50 may be sized and shaped to contact the body of the handle 16 to brace the removeable tool with respect to the handle and prevent pivoting of the removeable tool with respect to the handle, when in the operational position. The handle connector 26 of the pry bar 50C includes a plurality of openings 30, spaced apart along a longitudinal axis of the pry bar. The user can select which opening 30 of the pry bar 50C to insert the connector pin 28 through, thereby allowing the user to select the distance the prying end of the pry bar is from the end of the handle 16. When the pry bar 50C is connected to the handle 16, the pry bar is not pivotable (broadly, moveable) relative to the handle. In the illustrated embodiment, the prying end of the pry bar 50C includes a notch (e.g., V-shaped notch), although other configurations (e.g., beveled edge, a notch of a different shape) may be used without departing from the scope of the present disclosure.

With reference to FIGS. 6-13, the handle(s) 16 of the multi-tool 10 (broadly, the handles of the multi-tool kit 12) can come in various different configurations with various different tools (e.g., additional tools 48). FIGS. 6-13 illustrate four such handle configurations but other configurations may be used without departing from the scope of the present disclosure. The handle configurations are interchangeable with one another, so the user can pick and choose which two handles 16 (or one handle) to couple to a given tool head 14. As a result, the user can pick and choose the tool head 14 and the handle(s) 16 from the multi-tool kit 12 to assemble the multi-tool 10 as desired, such as to contain the necessary tools to perform a specific task or set of tasks (e.g., planned tasks for a trip or project). Because each handle 16 includes the additional tools 48, each handle can be used independently of the tool head 14 and the removeable tool 50. The removeable tools 50 are swappable amongst the different handle configurations, such that the handle configurations are not limited to the specific removeable tool described therewith. For example, the first handle configuration can include the fire starter 50D, the second handle configuration can include the pry bar 16B (see FIG. 14), etc.

FIGS. 6 and 7 illustrate a handle 16A of a first configuration. The handle 16A includes five additional tools 48: a knife blade 48A (with a non-serrated edge), a saw blade 48B, a large-size flat head drive tip 48C (for a flat head screw) (which may or may not include a file on one side thereof), a gut hook 48D, and a spike 49E (such as for punching a hole in a piece of material (e.g., leather)). In this configuration, the removeable tool 50 connected to the handle 16A is the caribener 50A.

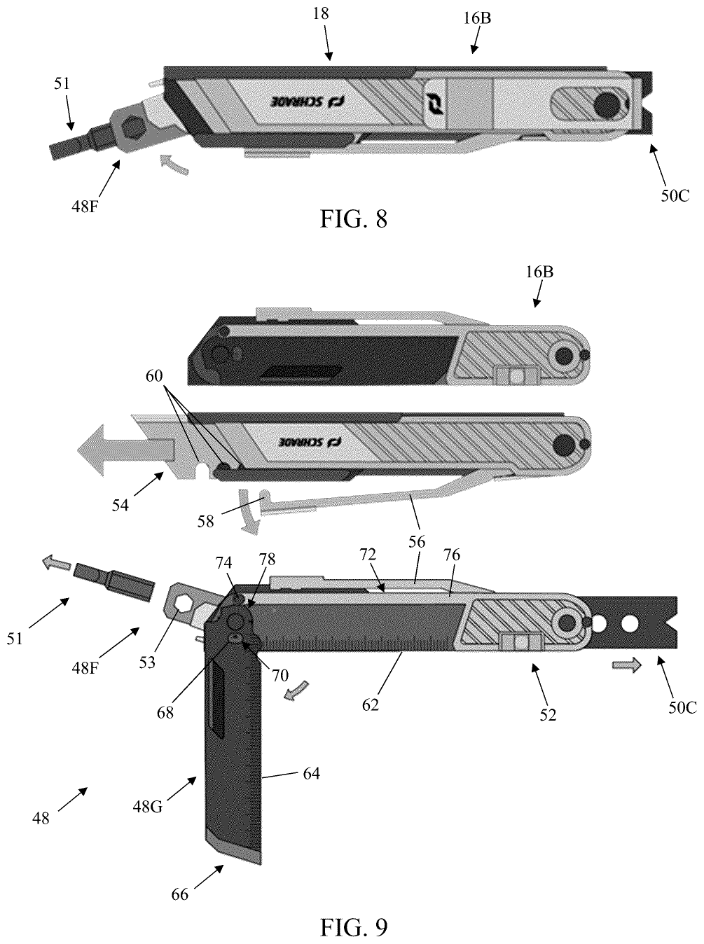

FIGS. 8 and 9 illustrate a handle 16B of a second configuration. In this configuration, the removeable tool 50 connected to the handle 16B is the pry bar 50C. The handle 16B includes two additional tools 48: a bit holder 48F (with a bit 51 (e.g., a screw driver bit)) and an angle tool 48G (e.g., a square leg or bar). The bit holder 48F and the angle tool 48G are connected to the handle body 18 via the second tool connector 22. The bit holder 48F removably receives the bit 51 in a receiver (e.g., blind bore that extends from an end of the bit holder 48F toward the second tool connector 22). The bit holder 48F may include a retainer (e.g., magnet) that secures the bit 51 in the receiver. The bit holder 48F also includes a lateral opening 53 sized and shaped to receive the bit 51. The lateral opening 53 extends generally perpendicularly to the blind bore. This positions the bit 51 90-degrees relative to the handle body 18 (e.g., longitudinal axis thereof), allowing more torque to be applied to the bit.

The angle tool 48G is multifunctional. The handle body 18 includes a first straight edge 62 and the angle tool 48G includes a second straight edge 64. Together, the first and second straight edges 62, 64 (broadly, angle tool arrangement) cooperate to form various angles of different degrees. The first and second straight edges 62, 64 are each blunt (e.g., not sharp like an edge of knife or saw). Desirably, the edge of the angle tool 48G opposite the second straight edge and the edge of the handle body 18 opposite the first straight edge 62 are also blunt. Thus, the angle tool 48G is not a knife or saw. The second straight edge 64 can be pivoted relative to the first straight edge 62 to form a 90-degree angle (as illustrated in FIG. 9) and/or one or more additional angles (e.g., any angle within the range of about 0-180-dgrees). The square bar 48G is pivotable between a stowed position and one or more (e.g., first, second, third, etc.) operational positions to form the various different angles (e.g., first, second, third, fourth, etc. angles). Each operational position corresponds to a different angle (e.g., 45-degree, 90-degree, 135-degree, 180-degree) formed between the straight edges 62, 64. For example, in one embodiment, a first operational position corresponds to a 45-degree angle formed by the straight edges 62, 64, a second operational position corresponds to a 90-degree angle (FIG. 9), a third operational position corresponds to a 135-degree angle, and a fourth operational position corresponds to a 180-degree angle (with the straight edges 62, 64 being co-axial). Other angles and/or more or less operational positions may be employed without departing from the scope of the present disclosure. One or both of the straight edges 62, 64 may include ruler markings or indicia (broadly, length indicia or rulering) (that desirably match and align when the angle tool 48G is at 180-degrees), such as in metric and/or imperial units.

The angle tool 48G may include a window or opening 68 (broadly, reference), and the handle body 18 may include one or more degree indicia 70 (e.g., degree measurement indicia). Each degree indicia 70 (e.g., first, second, third, etc. degree indicia) indicates the degree of one of the angles formed by the straight edges 62, 64. In one embodiment, each degree indicia 70 is a number (e.g., 45, 90, 135, 180) matching the degree of the formed angle to indicate what angle has been formed. The window 68 aligns with the degree indicia 70 (one at a time) to indicate the formed angle. The window 68 and degree indicia 70 are arranged relative to one another such that the window aligns with one of the degree indicia 70 (e.g., a first degree indicia) to permit the user or viewer to see said one degree indicia through the window when the angle tool 48G is in one of the operational positions. For example, the user can view the first degree indicia (but not any other degree indicia) through the window 68 when the angle tool 48G is in the first operational position, can view the second degree indicia (but not any other degree indicia) through the window when the square bars in the second operational position, etc. This enables the user to quickly determine the angle formed by the straight edges 62, 64 for a given operational position of the angle tool 48G. Other configurations can be used without departing from the scope of the present disclosure. For example, the locations of the reference (e.g., window) and degree indicia can be swapped, such that the reference is provided on the handle body and the degree indicia is on the angle tool.

The handle 16B desirably includes an angle tool retainer 72 to prevent the angle tool from pivoting relative to the handle body 18. The retainer 72 desirably sets and/or holds (e.g., positively locates) the angle tool at one or more set angles (e.g., 0, 45, 90, 135, and/or 180 degrees) (e.g., stowed position, operational positions) relative to the handle body 18. In the illustrated embodiment, the angle tool retainer 72 comprises a detent 74 biased against the angle tool 48G via a spring 76. The detent 74 is biased against a generally arcuate end of the angle tool 48G via the spring 76. The generally arcuate end desirably includes one or more keepers 78 that selectively engage the angle tool retainer to set and hold the angle tool 48G in the associated various positions. In one embodiment, each keeper 78 comprises a notch or recess sized and shaped to receive the detent 74, each notch corresponding to one of the set angles (e.g., the stowed position or one of the operational positions). Other configurations of the retainer and/or keeper (broadly, other retainer system) may be used without departing from the scope of the present disclosure. For example, the locations of the detent and keepers can be swapped among the handle body and angle tool.

In this embodiment, the angle tool 48G is not disposed in the recess 20 of the handle body 18 in the stowed position. Instead, in this handle configuration, the angle tool 48G is positioned on the outside or exterior of one of the side walls of the handle body 18, and the exterior of the side wall includes a recess (e.g., square bar recess or square recess) or angle tool receiving space (broadly, tool receiving space) the angle tool is disposed in when in the stowed position. In the stowed position, the angle tool 48G is positioned alongside the handle body 18 (e.g., side wall) such that the two straight edges 62, 64 are generally parallel to one another (e.g., 0-degrees). The tip (e.g., free end) of the angle tool 48G may include a chisel 66 (e.g., a chisel edge). The chisel edge of the chisel 66 may extend perpendicular or skewed relative to the straight edge 64 of the angle tool 48G. In the stowed position, the chisel 66 is disposed in the angle tool recess for safety.

The handle 16B also includes a bubble level 52 (broadly, a tool) mounted to one of the side walls of the handle body 18. The handle 16B also includes a (sliding, disposable) utility blade 54 (broadly, a tool). The utility blade 54 is moveably (e.g., slideably) received in the recess 20 (e.g., a section thereof) of the handle body 18. The handle 16B includes a lever 56 pivotably coupled to the handle body 18 with a retainer 58 (e.g., projection) that mates with one or more corresponding keepers 60 (e.g., recess or notch) in the utility blade to fix the position of the utility blade relative to the handle body. Different keepers 60 may correspond to different positions (e.g., stowed, first operational, second operational, etc.) of the utility blade 54 relative to the handle 16B. Manually pivoting (broadly, moving) the lever 56 to disengage the retainer 58 (from a keeper 60) permits the utility blade 54 to move (slide) (manually by the user) relative to the handle body 18.

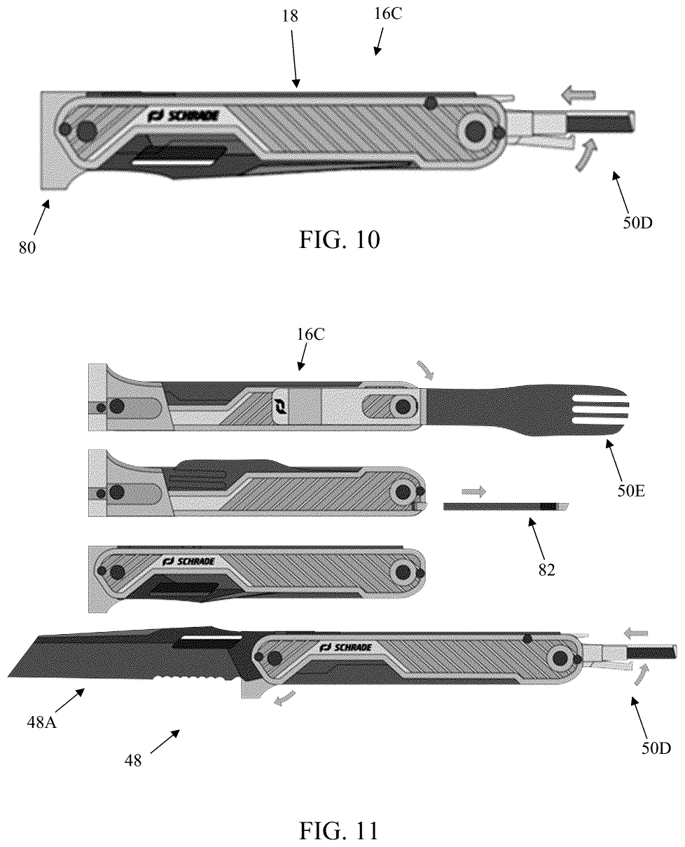

FIGS. 10 and 11 illustrate a handle 16C of a third configuration. In this configuration, two removeable tools 50 are connected to the handle 16C: the fire starter 50D and a utensil 50E (e.g., a fork). The handle 16B includes one additional tool 48: a knife blade 48A (with an edge having a serrated and non-serrated sections). The handle 16B also includes a hammer 80 (broadly, a tool). The hammer 80 generally forms an end of the handle body 18 and is fixed in position (not pivotable) relative to the handle body. The hammer 80 may be integral with the handle body 18 or mounted to the handle body. The hammer may include a stake puller for pulling stakes and/or nails and/or a bottle opening for opening bottles. The handle 16B also includes tweezers 82 (broadly, a tool) removeably disposed in a pocket or section of the recess 20.

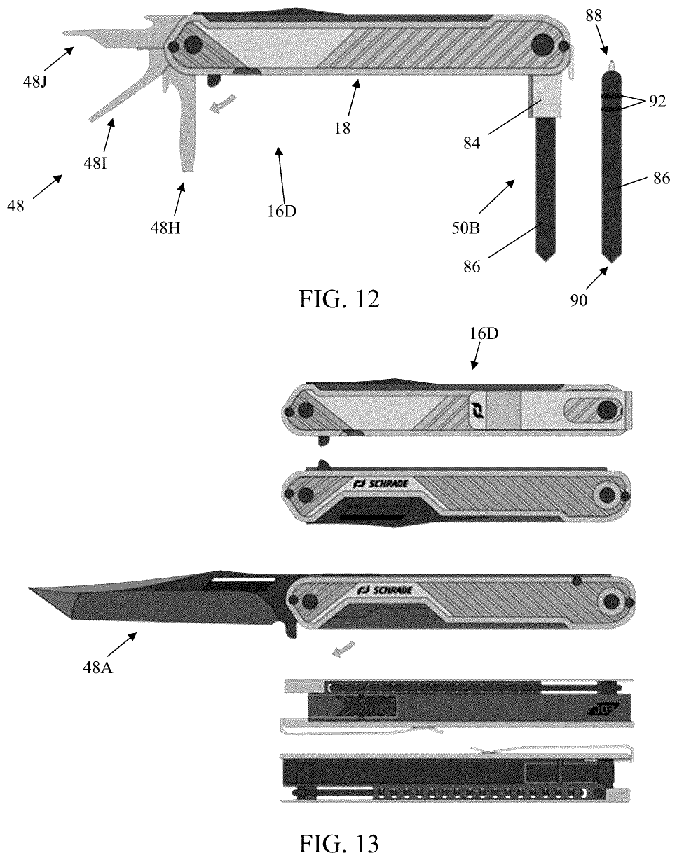

FIGS. 12 and 13 illustrate a handle 16D of a fourth configuration. The handle 16D includes four additional tools 48: a knife blade 48A (with a non-serrated edge), a medium-size flat head drive tip 48H (for a flat head screw) (which may or may not include a file on one side thereof and/or may or may not include a bottle opener), a small or micro-size flat head drive tip 48I (for a flat head screw) (which may or may not include a bottle opener), and a micro Philips head drive tip 48J (for a Philips head screw).

In this configuration, the removeable tool 50 connected to the handle 16D is the combination pen/glass breaker 50B. The combination pen/glass breaker 50B includes a holder 84 and a pen/breaker shaft or rod 86 (made of metal such as steel) which includes the pen 88 at one end and a pointed end or tip 90 at the other. The pointed end 90 (broadly, glass breaker) can be used to break glass. An interference fit, such as with one or more O-rings 92 (adjacent one or both ends of the shaft 86), secures the shaft 86 to the holder 84 (in a blind bore thereof) and allows the user to select which end of the shaft is exposed (for writing or breaking) and which end is connected to the holder.

Referring to FIG. 14, the multi-tool kit 12 can include one or more handles 16 (same or different configurations), none or one or more tool heads 14 (same or different types), and none or one or more removeable tools 50 (same or different types), and combinations thereof. For example, the multi-tool kit 12 illustrated in FIG. 14 includes two handle 16 (e.g., the handle 16A of the first handle configuration and the handle 16B of the second handle configuration), a single tool head 14 (e.g., the plier tool head 14A), and two removeable tools 50 (e.g., the pry bar 50C and the caribener 50A). In one embodiment, the multi-tool kit 12 includes one or more of each tool head 14A-C, one or more of each removeable tool 50A-E, and one or more of each handle 16A-D (or any sub-combination thereof, include none of any component). It is understood the multi-tool kit 12 may include enough components to form multiple multi-tools 10 at the same-time. Accordingly, the user is able to assemble the components of the multi-tool kit 12 into various different multi-tools 10 (e.g., multi-tool assemblies). For example, in FIG. 14, the multi-tool kit 12 is shown being transformed from initially being assembled as two different multi-tools 10 (each having a single handle 16 connected to one removeable tool 50), to a single-multi-tool (having a tool head 14 connected to the two handles 16 previously connected to the removeable tools). In another example, the multi-tool kit 12 includes at least two tool heads 14 and at least two handles 16. In this case, the multi-tool kit 12 can be assembled into a first assembly where the two handles 16 (e.g., handles 16C, 16D of the third and fourth handle configurations) are connected to one of the tool heads 14 (e.g., the pliers tool head 14A) or can be assembled into a second assembly where the two handles are connected to the other tool head (e.g., the wire stripper tool head 14C). Thus, the multi-tool kit 12 can be assembled into numerous different multi-tools 10 depending upon which and how many of each component (e.g., tool heads 14, handles 16, and/or removeable tools 50) are included in the kit. It is understood the possible multi-tool assemblies are apparent to the skilled person with any given combination and number of components in a multi-tool kit 12.

As used herein and in the drawings, when a reference character includes a reference numeral not followed by a letter, such a reference character refers to all elements designated at least in part by the reference numeral. Moreover, when a reference character includes the reference numeral flowed by a letter, such as “A,” such a reference character refers to a particular element or sub-group of elements from the group of elements. For example, as used herein and in the drawings, reference numeral “14” designates all tool heads, while reference numeral “14” followed by a letter, such as “14A,” designates a specific tool head, in this case the pliers tool head. In another example, as used herein and in the drawings, reference numeral “16” designates all handles, while reference numeral “16” followed by a letter, such as “16A,” designates a specific handle, in this case the handle of the first configuration.

It is appreciated that the person of ordinary skill in the art is readily able to determine the scope of terms of degree such as, but not limited to, “about,” “substantially,” and “generally.” For example, when a term of degree is used in relation to a numeric value, the person of ordinary skill in the art understands that the term of degree covers an inclusive range of plus or minus 10% of the numeric value, unless clearly indicated or stated otherwise.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

Modifications and variations of the disclosed embodiments are possible without departing from the scope of the invention defined in the appended claims. For example, where specific dimensions are given, it will be understood that they are exemplary only and other dimensions are possible. As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A multi-tool comprising:
a first tool including a handle connector; and
a handle including a handle body having a tool receiving space, the handle including a tool connector configured to releaseably connect to the handle connector of the first tool to releaseably connect the first tool and the handle together, the handle including a second tool different than the first tool, the second tool supported by the handle body, the second tool being moveable between a stowed position in which the second tool is disposed in the tool receiving space of the handle body and an operational position in which the second tool is disposed outside the tool receiving space.

2. The multi-tool of claim 1, wherein the handle connector of the first tool and the tool connector of the handle form a pivot connection when the handle connector and the tool connector are connected together that permits the first tool to pivot between a stowed position in which the first tool is disposed in the tool receiving space and an operational position in which the first tool is disposed outside the tool receiving space.

3. The multi-tool of claim 2, wherein the handle connector is a first handle connector, the handle is a first handle, the handle body is a first handle body, the tool connector is a first tool connector, and the tool receiving space is a first tool receiving space, wherein the first tool includes a second handle connector, wherein the multi-tool further comprises:
a second handle including a second handle body having a second tool receiving space, the second handle including a second tool connector configured to releaseably connect to the second handle connector of the first tool to releaseably connect the first tool and second handle together, the second handle including a third tool different than the first tool, the third tool supported by the second handle body, the third tool being moveable between a stowed position in which the third tool is disposed in the second tool receiving space of the second handle body and an operational position in which the third tool is disposed outside the second tool receiving space.

4. The multi-tool of claim 3, wherein the pivot connection is a first pivot connection, and wherein the second handle connector of the first tool and the second tool connector of the second handle form a second pivot connection when the second handle connector and the second tool connector are connected together that permits the first tool to pivot between a stowed position in which the first tool is disposed in the second tool receiving space and an operational position in which the first tool is disposed outside the second tool receiving space.

5. The multi-tool of claim 4, wherein the first tool comprises one of a pliers tool head, a scissors tool head, or a wire stripper tool head.

6. The multi-tool of claim 1, wherein the first tool comprises one of a caribener, a pen, a glass breaker, a pry bar, or a fire starter.

7. The multi-tool of claim 1, wherein the handle connector includes an opening and the tool connector includes a pin sized and shaped to be inserted into the opening.

8. The multi-tool of claim 7, wherein the pin is moveable between a connecting position in which the pin is arranged to extend into the opening of the handle connector to connect the first tool and the handle together and a release position in which the pin is arranged to not extend into the opening of the handle connector to permit the separation of the first tool and the handle.

9. The multi-tool of claim 8, wherein the pin is configured to linearly slide relative to the handle body between the connecting and release positions.

10. The multi-tool of claim 8, further comprising a retainer configured to hold the pin in at least one of the connecting position or the release position.

11. The multi-tool of claim 10, wherein the retainer is configured to hold the pin in the connecting position and the release position, wherein the pin is supported by the handle body in both the connecting position and the release position.

12. The multi-tool of claim 8, wherein an end of the pin is arranged to be pressed by a user when the pin is in the connecting position to move the pin toward the release position.

13. The multi-tool of claim 1, wherein the handle connector and the tool connector are manually connectable and disconnectable without the use of a tool.

14. A multi-tool kit comprising:
a first tool including a first handle connector and a second handle connector;
a second tool different than the first tool, the second tool including a third handle connector and a fourth handle connector;
a first handle including a first handle body and a first tool connector; and
a second handle different than the first handle and including a second handle body and a second tool connector,
the multi-tool kit being assembleable into a first assembly and a second assembly, wherein in the first assembly:
the first tool connector of the first handle is connected to the first handle connector of the first tool and the second tool connector of the second handle is connected to the second handle connector of the first tool; and
wherein in the second assembly:
the first tool connector of the first handle is connected to the third handle connector of the second tool and the second tool connector of the second handle is connected to the fourth handle connector of the second tool.

15. The multi-tool kit of claim 14, wherein the first handle body includes a first tool receiving space, and the second handle body includes a second tool receiving space, and wherein:
in the first assembly:
the first tool connector of the first handle and the first handle connector of the first tool form a first pivot connection;
the second tool connector of the second handle and the second handle connector of the first tool form a second pivot connection; and
the first and second pivot being configured to permit the first and second handles to pivot between a first stowed arrangement in which the first tool is disposed in the first tool receiving space of the first handle and the second tool receiving space of the second handle and a first operational arrangement in which the first tool is disposed outside the first tool receiving space of the first handle and the second tool receiving space of the second handle; and
in the second assembly:
the first tool connector of the first handle and the third handle connector of the second tool form a third pivot connection;
the second tool connector of the second handle and the fourth handle connector of the second tool form a fourth pivot connection; and
the third and fourth pivot connections being configured to permit the first and second handles to pivot between a second stowed arrangement in which the second tool is disposed in the first tool receiving space of the first handle and the second tool receiving space of the second handle and a second operational arrangement in which the second tool is disposed outside the first tool receiving space of the first handle and the second tool receiving space of the second handle.

16. The multi-tool kit of claim 14, further comprising a third handle different than at least one of the first or second handles, the third handle including a third handle body and a third tool connector, the third tool connector being configured to connect to the first handle connector of the first tool to connect the first tool and the third handle together and to connect to the third handle connector of the second tool to connect the second tool and the third handle together.

17. The multi-tool kit of claim 14, wherein the first tool comprises one of a pliers tool head, a scissors tool head, or a wire stripper tool head, and the second tool comprises a different one of the plier tool head, the scissors tool head, or the wire stripper tool head.

18. A multi-tool comprising:
a handle body having a tool receiving space, the handle body including a first straight edge;
a first tool supported by the handle body, the first tool being moveable with respect to the handle body between a stowed position in which the first tool is disposed in the tool receiving space of the handle body and an operational position in which the second tool is disposed outside the tool receiving space; and
an angle tool supported by the handle body and including a second straight edge, the second straight edge being pivotable with respect to the handle body from a stowed position to a first operational position in which the first and second straight edges form a first preset angle and to a second operational position in which the first and second straight edges form a second preset angle different than the first preset angle;
wherein the handle body and the angle tool form an angle tool arrangement; and
wherein the angle tool arrangement includes a retainer configured to positively locate and retain the angle tool in the first and second operational positions, or the angle tool arrangement includes degree indicia and a reference moveable with respect to the degree indicia to permit a user to identify the first and second straight edges form the first and second preset angles based on a location of the reference relative to the degree indicia.

19. The multi-tool of claim 18, wherein the angle tool arrangement includes a window and the degree indicia includes a first degree indicia indicating 90-degrees and a second degree indicia indicating a degree of the second angle, and wherein the window, the first degree indicia, and the second degree indicia are arranged such that the window is positionable in registration with the first degree indicia to permit the user to see the first degree indicia through the window when the angle tool is in the first operational position and such that the window is positionable in registration with the second degree indicia to permit the user to see the second degree indicia through the window when the angle tool is in the second operational position.

20. The multi-tool of claim 18, wherein the handle body is a first handle body, and the multi-tool includes a second handle body pivotably connected to the first handle body.
